(19) United States
(12) Patent Application Publication
(10) Pub. No.: US 2020/0057986 A1
(43) Pub. Date: Feb. 20, 2020

(54) PROFORMA DISBURSEMENT SYSTEM AND METHOD

(71) Applicant: DA-Desk FZ LLC, Dubai (UZ)

(72) Inventors: BRUNO Jerzy DESZCZYNSKI, Dubai (AE); Alan Cassar, Dubai (AE)

(21) Appl. No.: 16/534,245

(22) Filed: Aug. 7, 2019

Related U.S. Application Data
(60) Provisional application No. 62/718,896, filed on Aug. 14, 2018.

(51) Int. Cl. G06Q 10/08; G06Q 10/04; G06Q 10/06

(52) U.S. Cl. CPC G06Q 10/0831; G06Q 10/047; G06Q 10/08345; G06Q 10/0838; G06Q 10/06375

(57) ABSTRACT

A system for generating proforma disbursement accounts including a structured data source, said data source including historical port call cost information for both tariffed and non-tariffed costs; a similarity engine operable to compare historical tariffed items against a proposed port call disbursement account to estimate a tariffed item cost; and a correlation engine, said correlation engine operable to estimate, based on historical costs, estimated costs for non-tariffed port call items. Collectively, these elements operate to estimate costs for non-tariffed items and, with the tariffed item costs, effectuate a synthetic proforma disbursement account for a vessel's port of call.

### PRIORITY

This application claims the benefit of co-pending provisional patent application 62/718,896 filed on Aug. 14, 2018 by the same inventors which is included by reference, together with its appendix, as if fully set forth herein.

### BACKGROUND

Port Costs are crucial elements of a maritime vessel's voyage expenses. They form the 3rd largest voyage cost and largely drive the end-price of goods being transported. Shipping companies often rely on agencies to predict and control port costs. This reliance on agencies may expose a shipping company to potential corruption as the organization delivering services in the port is also the controller. Accordingly, there should be an independent, more transparent and less corruption-prone method of calculating port costs independent of the parties delivering the port services. Through the years, the cost of port services around the world has increased in varying magnitudes. However, the ability of shipping companies' to track and analyze voyage port cost changes remains rudimentary. Current systems do not possess the functionality required by the stakeholders to effectively and efficiently estimate port-costs, which adds instability to international pricing.

A Proforma Disbursement Account (PDA) is a cost estimate statement sent by a ship's agent at a port to the shipowner in advance of the ship's call at the port. Conventionally, it consists of the expenses that are likely to be incurred, including, but not limited to, port charges, pilotage, towage and the agent's commission. This account is used to help the ship owner estimate the viability of a voyage and serves as a request by the agent for sufficient funds to be made available prior to the ship's arrival.

Among the items listed in the PDA are tariffed and non-tariffed costs. A tariffed item is one where the exact cost of the service is published by either the port authority or some similar entity and is made publicly available to everyone. Each port generally makes its tariffs available to potential port users. Although, in some instances, tariffed items are static, tariffed items are generally based on parameters which are not static, such as total number of days the vessel will stay in port, total number of tugs used, total number of hours or distance of pilotage, and similar costs. Because these costs are often variable, it is impossible to apply the tariff to estimate the port costs in advance without more information.

There are two types of non-tariffed items. The first one is where a vessel operator and a service provider sign an agreement and define how much the service will cost. This may be referred to as a customer-specific tariff. The second type of non-tariffed items is where there is no agreement and the service provider charges how much he believes is correct or uses a figure that is not publicly available. Often, non-tariffed items may be known in advance and available for the PDA. Examples of non-tariffed items may be agency fees, launch services, communications, emergency situations, and the like.

Because non-tariffed items are not known in advance and tariffed item costs may widely vary, shippers cannot know the cost of a port call in advance. Moreover, rapidly changing international financial conditions may modify the profitability of a proposed voyage and, therefore, alter the financial decision-making of whether a voyage should commence, or if voyage specifications should change. Accordingly, better tools are needed for vessel port call planning and management.

### BRIEF DESCRIPTION OF THE DRAWINGS

FIG. 1 shows a functional block diagram of a client server system.

FIG. 2 shows an illustration of certain steps that may be employed to effectuate an embodiment according to the current disclosure.

FIG. 3 shows a representation of a user interface which may be employed in some embodiments.

### SUMMARY

A system for generating proforma disbursement accounts including a structured data store, said data store including historical port call cost information for both tariffed and non-tariffed costs; a similarity engine operable to compare historical tariffed items against a proposed port call disbursement account to estimate a tariffed item cost; and a correlation engine, said correlation engine operable to estimate, based on historical costs, estimated costs for non-tariffed port call items. Collectively, these elements operate to estimate costs for non-tariffed items and with the tariffed item costs, effectuate a synthetic proforma disbursement account for a vessel's port of call.

The system described herein provides an aid for worldwide maritime vessel management for rapidly changing international financial conditions. The use of a synthetic proforma disbursement account assists in developing pricing and other operational parameters for a voyage. For example, and without limitation, whether a voyage should commence, or if voyage specifications should change.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### Detailed Description

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, smartphones, personal digital assistants (PDAs) and the like.

The processing system may also include mass storage devices such as disk drives and flash memory modules as well as connections through I/O devices to servers or remote processors containing additional storage devices and peripherals.

Certain embodiments may employ multiple servers and data storage devices, thus allowing for operation in a cloud or for operations drawing from multiple data sources. The inventors contemplate that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smartphone, PDA, laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

The methods and techniques described herein may be performed on a processor-based device. The processor-based device will generally comprise a processor attached to one or more memory devices or other tools for persisting data. These memory devices will be operable to provide machine-readable instructions to the processors and to store data, including data acquired from remote servers.

### Client Server Processing

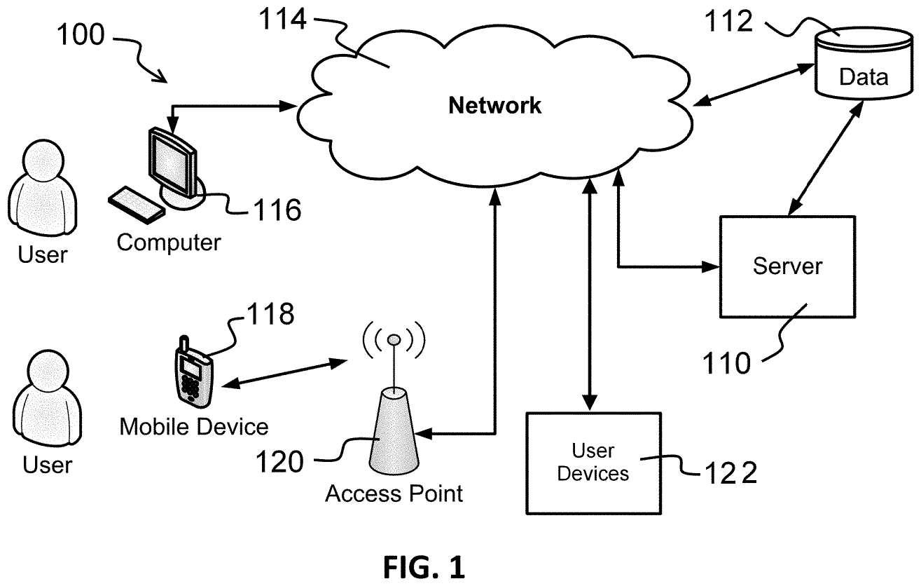

FIG. 1 shows a functional block diagram of a client server system 100 that may be employed for some embodiments according to the current disclosure. In the FIG. 1, a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and the client indicates which instructions are transmitted and executed. In addition, the client may, at times, provide for machine-readable instructions to the server, which in turn executes them. Several forms of machine-readable instructions are conventionally known, including applets, and are written in a variety of languages including Java and JavaScript.

Client-server applications also provide for software as a service (SaaS) applications where the server provides software to the client on an as-needed basis.

In addition to the transmission of instructions, client-server applications also include transmission of data between the client and server. Often, this entails data stored on the client to be transmitted to the server for processing. The resulting data is then transmitted back to the client for display or further processing.

One having skill in the art will recognize that client devices may be communicably coupled to a variety of other devices and systems, such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

### Process

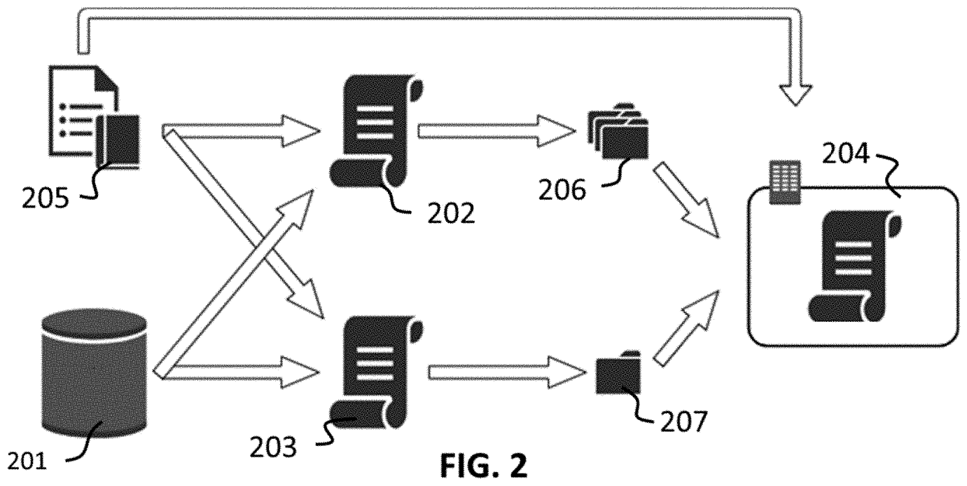

FIG. 2 shows an illustration of certain steps that may be employed to effectuate an embodiment according to the current disclosure. In FIG. 2, item 201 is structured data store including historical cost information, both tariffed and non-tariffed, for a variety of historical port calls. In addition to cost information is vessel and cargo type, port and other shipping information.

In FIG. 2, a proposed PDA 205 is supplied to a processor which is coupled to the data store 201. The processor includes instructions to apply a similarity algorithm 202 for determining tariffed port calls similar to those in the proposed PDA 105. Once the similarity is identified, a list of similar port calls is generated 206 along with a percent similarity.

The processor also receives the proposed PDA 205 and applies a non-tariffed cost model 203 which, using historical cost data 201, provides a predicted non-tariff cost estimate 107.

Both the non-tariffed costs determination 107 and the tariffed cost determinations 106 are presented to a user 204 for review. In some embodiments, however, allowable variances may be predetermined. If the predicted tariffed and non-tariffed costs are within the allowable range, then the PDA is automatically generated. For example, and without limitation, the similarity may be 100% and the non-tariffed cost estimate may be within a predetermined range, so the PDA is generated.

### Similarity Algorithm

The similar port calls algorithm may be staggered, to find perfect matches first, then relax the rules one at a time until there are enough similar disbursement accounts to make an estimate. Every level may have a similarity number attached to it. For example, and without limitation, perfectly matched port calls will be 100% similar. Less similar port calls will have a lower number. Listed herein are different options for generating a port call similarity:

Algorithm 1
1. Perfect match:
   a. same port
   b. same operator
   c. same vessel IMO number (unique ID)
   d. same agent
   e. same activity
   f. within the last 12 months
2. Next level—same as above except:
   a. Remove same vessel match
   b. Add same vessel type (bulk carrier, oil/chemical . . . )
   c. Add same vessel sub type (Handymax, VLCC . . . )
3. Next level same as above except the following:
   a. Remove same agent match
4. Next level same as above except the following:
   a. Remove same vessel subtype
   b. Add deadweight tonnage (DWT)+−25%
5. Next level same as above except the following:
   a. Remove same activity
   b. Remove same vessel type
6. Next level same as above except the following:
   a. Expand ETA to within the past 3 years.

Here, the characteristics which are likely to be the most important for determining similarly are matched and characteristics are removed from the algorithm until the best match is found. At any stage, if there are more port calls than required, preference may be given to most recent port call.

Algorithm 2
1. Perfect match:
   a. same port
   b. same operator
   c. same vessel IMO
   d. same agent
   e. same activity
   f. ETA of today—365 days
2. Next level same as above except the following:
   a. Remove same vessel match
   b. Add same vessel type (bulk carrier, oil/chemical . . . )
   c. Add same vessel sub type (Handymax, VLCC . . . )
   d. Add DWT+−5%
3. Next level same as above except the following: (moved from lower level.)
   a. Remove same agent match.
4. Next level same as above except the following:
   a. Remove DWT+−5%
   b. Add DWT+−10%
5. Next level same as above except the following:
   a. Remove DWT 10%
6. Next level same as above except the following:
   a. Remove same vessel subtype
   b. Add DWT+−25%
7. Next level same as above except the following:
   a. Remove same activity
   b. Remove same vessel type
8. Next level same as above except the following:
   a. Expand ETA to today—800 days

Different variations on the above themes are shown in the attached Appendix which is included by reference as if fully set forth herein. The cargo parameters and vessel characteristics may all be added or removed from certain algorithms to effectuate a suitable similarity match.

### Non-Tariffed Items Models

Not all non-tariffed items lend themselves to historical comparisons to estimate costs. Accordingly, in some embodiments, items like agency fees and similar fees may require advanced prediction processes. Moreover, some embodiments may employ a custom regression or correlation models operable to generate predicted non-tariffed cost items for similar port calls or for providing cost items values that would allow for synthetic PDA creation and quicker checking of cost items values.

In some embodiments, the regression method may be based on a primary correlation among features like location, country, wet/dry cargo type, vessel-details to cost items. Further, correlation coefficients may be generated for specific locations and for specific countries. Location coefficients may be defined in both US dollars and in local currencies. Exemplary variables include:
Location ID
Cargo Type
Dry weight tonnage
Net register tonnage (NRT)
Gross register tonnage (GRT)
Length overall (LOA)
   The location ID may be for a specific location such as a port or berth in a port, whereas for country-based variables, the country name or code may be used.

By generating a matrix with the above variable, a correlation showing the change in value of the agency fee or any non-tariffed items with respect to the country of location may be created. Once correlation variables are generated for every location and country, a polynomial function using linear regression may be employed. This function may be represented as f(af)=aDWT±bLOA± . . . +c, where a, b, etc., are the coefficients. Accordingly, a representative calculation for determining the agency fee may be:

agency_fee˜a₀·DWT+a₁·DWT^{1/2}+a₂·DWT^{1/3}+a₃·DWT^{2/3}+a₄·NRT+a₅·NRT^{1/2}+a₆·NRT^{1/3}+a₇·NRT^{2/3}+a₈·GRT+a₉·GRT^{1/2}+a₁₀·GRT^{1/3}+a₁₁·GRT^{2/3}+a₁₂·LOA+a₁₃·LOA^{1/2}+a₁₄·LOA^{1/3}+a₁₅·LOA^{2/3}+a₁₆·LOA²+a₁₆·LOA³

Initial values may be presumed and corrected based on comparisons to historical data until satisfactory coefficients are obtained. In operation, a full set of parameters may be used to calculate the agency fee or any non-tariffed item. In some embodiments, helper functions may approximate cost with fewer variables, for example, and without limitation, using only vessel type and DWT, LOA, gross tonnage, net tonnage, and the like. In some embodiments, a cargo category (DRY or WET) may be employed to divide the datasets for estimations. For example: LOA/GT/NT=aDWTb+c. This allows for data-driven calculations using structured query languages (SQL).

In the example shown, If DWT is null, data averaging may be used. For example, and without limitation, a function such as @dwt_est=(dwtmin+dwtmax)/2, where dwtmin is the 1st decile and dwtmax the 9th, may provide an estimate that is easy to implement in SQL.

Certain embodiments may modify the regression behavior to continuously verify the model's accuracy. For example, and without limitation, checking that the agency fee/non-tariffed cost value is within the defined range of a minimum and maximum for a certain group.

### Synthetic PDAs

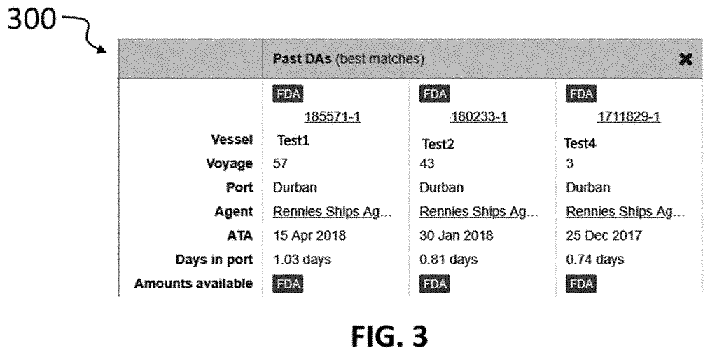

FIG. 3 shows a representation of a user interface which may be employed in some embodiments. FIG. 3 shows the best matches based on past disbursements accounts (DAs). The new agency module should show similar port calls to a shipping agent on the screen allowing a user to manually populate the PDA or, if satisfactory, auto-fill the screen creating a “synthetic” PDA. This will facilitate data entry since the user can easily compare with previous calls or substitute the data entry with an automated process. An agency module (or engine) may include a feature where the agent can pre-fill the PDA values from a selected previous port call determined to be “similar” to one under consideration. This may allow the agent to also modify the copied values but within a certain ruleset to assure correctness.

In certain embodiments, if the predicted tariffed and non-tariffed costs are within a pre-set allowable range, then the synthetic PDA is automatically generated, alleviating the need for user intervention.

The above illustration provides many different embodiments or embodiments for implementing different features of the invention. Specific embodiments of components and processes are described to help clarify the invention. These are, of course, merely embodiments and are not intended to limit the invention to that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A system for generating synthetic proforma disbursement accounts including:
a structured data store, said data store including historical port call cost information for both tariffed and non-tariffed costs;
a similarity engine operable to compare historical tariffed items against a proposed port call disbursement account to estimate a tariffed item cost;
a correlation engine, said correlation engine operable to estimate, based on historical costs, a cost for a non-tariffed port call item,
wherein the estimated costs for non-tariffed items and the tariffed item costs effectuate a synthetic proforma disbursement account.

2. The system of claim 1 wherein the similarity engine compares port call matches by initially applying a first set of rules and altering those rules until enough similar disbursement accounts are identified.

3. The system of claim 1 wherein the non-tariffed port call item cost is estimated by a regression analysis of historical costs.

4. The system of claim 1 wherein the non-tariffed port call item cost is estimated by a correlation model of historical non-tariffed port call costs.

5. The system of claim 4 wherein the correlation model includes:
a matrix, said matrix correlating location information with non-tariffed item cost information, wherein the correlation engine performs a linear regression to calculate non-tariffed port costs.

6. The system of claim 1 wherein the system further includes:
a display engine operable to present the synthetic proforma disbursement to a user and receive a modifying input from the user.

7. One or more processor-readable storage devices containing non-transitory processor-readable instructions directing a processor to perform a method including:
querying a structured data store, said data store including historical port call cost information for both tariffed and non-tariffed costs;
calculating a similarity value between historical tariffed items and a proposed port call disbursement account in response to said querying, and
generating a synthetic proforma in response to the calculating.

8. The devices of claim 7 wherein the similarity is calculated by applying a first set of rules and altering those rules until a similar disbursement account is identified.

9. The devices of claim 7 wherein the method further includes:
predicting a non-tariffed port call item cost by applying a regression analysis of historical costs.

10. The devices of claim 7 wherein the method further includes:
predicting a non-tariffed port call item cost using a correlation model of historical non-tariffed port call costs.

11. The devices of claim 10 wherein the method further includes:
correlating location information with non-tariffed item cost, wherein the correlation engine performs a linear regression to calculate non-tariffed port costs.

12. The devices of claim 7 further including:
displaying the synthetic proforma disbursement to a user, and
receiving a modifying input from the user.
